(19) United States
(12) Patent Application Publication
(10) Pub. No.: US 2007/0152149 A1
(43) Pub. Date: Jul. 5, 2007

(54) SYSTEMS AND METHODS FOR CALCULATING ION FLUX IN MASS SPECTROMETRY

(76) Inventors: Gordana Ivosev, Etobicoke (CA); Nic Bloomfield, Newmarket (CA)

Correspondence Address: BERESKIN AND PARR, 40 KING STREET WEST, BOX 401, TORONTO, ON, M5H 3Y2, CA

(21) Appl. No.: 11/619,858

(22) Filed: Jan. 4, 2007

Related U.S. Application Data
(60) Provisional application No. 60/756,234, filed on Jan. 5, 2006.

(51) Int. Cl. B01D 59/44

(52) U.S. Cl. 250/282

(57) ABSTRACT

Systems and methods for calculating ion flux. In one embodiment, a mass spectrometer includes an ion source for emitting a beam of ions from a sample through a plurality of pulses during an analysis period, and a detector positioned downstream of said ion source. A clock is provided which is configured to determine a repeatable series of bins, wherein each bin in the repeatable series will correspond to a corresponding pulse time segment in every pulse. Additionally a controller is provided which is operatively coupled to the detector and to the clock and configured to determine the total number of pulses during the analysis period. The controller is further configured to determine for at least one bin in the repeatable series, the number of corresponding pulse time segments in which no ion impact was detected during the analysis period. The controller is also configured to calculate the ion flux corresponding to the at least one bin and wherein said ion flux is calculated to be correlated to the probability of not detecting an ion impact during pulse time segments which correspond to the at least one bin in the repeatable series.

### FIELD OF THE INVENTION

The present invention relates generally to the field of mass spectrometry.

### BACKGROUND OF THE INVENTION

Mass spectrometers are used for producing mass spectrum of a sample to find its composition. This is normally achieved by ionizing the sample and separating ions of differing masses and recording their relative abundance by measuring intensities of ion flux. For example, with time-of-flight (TOF) mass spectrometers, ions are pulsed to travel a predetermined flight path. The ions are then subsequently recorded by a detector. The amount of time that the ions take to reach the detector, the “time-of-flight”, may be used to calculate the ion's mass to charge ratio, m/z.

However, to date, the detectors (also known as anodes) typically used in mass spectrometers are not able to distinguish between the impact of one or more ions during a specific segment of time or bin. As a result, a detector is unable to determine if more than one ion has impacted with the detector during a bin period. Information is lost, reducing the dynamic range of the spectrometer.

The applicants have accordingly recognized a need for systems and methods for more efficiently calculating ion flux in mass spectrometry.

### SUMMARY OF THE INVENTION

In one aspect, the present invention is directed towards a method for calculating at least one ion flux for a sample during an analysis period. The method includes the steps of:
(a) generating a plurality of pulses, wherein during each pulse a beam of ions is emitted from the sample;
(b) determining a repeatable series of bins, wherein each bin in the repeatable series will correspond to a corresponding pulse time segment in every pulse;
(c) detecting the impact of ions on a detector during each pulse;
(d) determining the total number of pulses during the analysis period;
(e) for at least one bin in the repeatable series, determining the number of pulses in which no ion impact was detected during the corresponding pulse time segments;
(f) calculating the ion flux, wherein said ion flux is correlated to the probability of not detecting an ion impact during pulse time segments which correspond to the at least one bin in the repeatable series.

In another aspect, the present invention is directed towards a mass spectrometer. The mass spectrometer includes an ion source for emitting a beam of ions from a sample through a plurality of pulses during an analysis period, and a detector positioned downstream of said ion source. A clock is provided which is configured to determine a repeatable series of bins, wherein each bin in the repeatable series will correspond to a corresponding pulse time segment in every pulse. Additionally a controller is provided which is operatively coupled to the detector and to the clock and configured to determine the total number of pulses during the analysis period. The controller is further configured to determine for at least one bin in the repeatable series, the number of corresponding pulse time segments in which no ion impact was detected during the analysis period. The controller is also configured to calculate the ion flux corresponding to the at least one bin, wherein said ion flux is calculated to be correlated to the probability of not detecting an ion impact during pulse time segments which correspond to the at least one bin in the repeatable series.

In a further aspect, the invention is directed towards a method for calculating at least one ion flux for a sample. The method includes the steps of:
(a) collecting a group of ions from the sample, wherein each ion in the group has substantially the same m/z as every other ion in the group;
(b) emitting the group of ions;
(c) detecting the impact of emitted ions on a detector during a pre-determined detection period;
(d) determining the total amount of time within the detection period in which the detector did not detect the impact of emitted ions;
(e) calculating the ion flux of the ions, wherein said ion flux is correlated to the probability of not detecting an ion impact during the detection period.

In yet another aspect, the invention is directed towards a mass spectrometer including an ion source, a detector, a clock and a controller. The ion source is configured to emit a group of ions from the sample, wherein each ion in the group has substantially the same m/z as every other ion in the group. The detector is positioned downstream of said ion source and configured to detect the impact of emitted ions on the detector during a pre-determined detection period. The clock is configured to determine the total amount of time within the detection period in which the detector did not detect the impact of emitted ions. The controller is operatively coupled to the detector and to the clock and configured to calculate the ion flux of the ions, wherein said ion flux is correlated to the probability of not detecting an ion impact during the detection period.

### BRIEF DESCRIPTION OF THE DRAWINGS

The present invention will now be described, by way of example only, with reference to the following drawings, in which like reference numerals refer to like parts and in which:

FIG. 1 is a schematic diagram of a mass spectrometer made in accordance with the present invention; and

FIG. 2 is a flow diagram illustrating the steps of a method of the present invention.

### DETAILED DESCRIPTION OF THE INVENTION

As used in the application,

“detector” means an ion detector which, either, outputs an analog signal or a digital signal corresponding to the number of ions measured by the detector;

“analysis period” means the time duration that the signal from the detector is used for the analysis;

“bin” means one or more segments of time of the analysis period so that the analysis period can comprise of one or a repeatable series of bins. Each bin can correspond to a specific m/z value or a range of m/z values;

“bin period” means the time duration of a single bin;

“beam of ions” means generally a discrete group of ions, a continuous stream of ions or a pseudo continuous stream of ions; and

“pulse” means generally any waveform used to cause ions to be emitted for the mass spectrometry analysis. A part of the pulse, such as the leading edge of the pulse, can be use to trigger the start of a series of bins. Similarly, a beam of ions can be pulsed so to produce a pulsed beam of ions, or further, a pulse can be use to trigger the analysis period of a beam of ions.

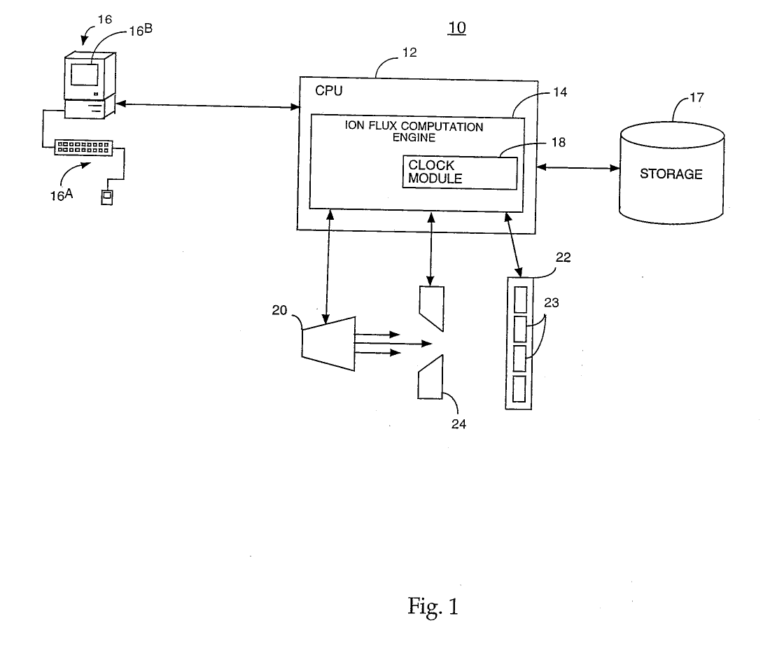

Referring to FIG. 1, illustrated therein is a TOF mass spectrometer, referred to generally as 10, made in accordance with the present invention. The spectrometer 10 comprises a processor or central processing unit (CPU) 12 having a suitably programmed ion flux computation engine 14. An input/output (I/O) device 16 (typically including an input component 16^{A} such as a keyboard or control buttons, and an output component such as a display 16^{B}) is also operatively coupled to the CPU 12. Data storage 17 is also preferably provided. The CPU 12 will also include a clock module 18 (which may form part of the computation engine 14) configured for determining a repeatable series of bins which will be discussed in greater detail, below.

The spectrometer 10 also includes an ion source 20, configured to emit a beam of ions, generated from the sample to be analyzed. As will be understood, the beam of ions from the ion source 20 can be in the form of a continuous stream of ions; or the stream can be pulsed to generate a pulsed beam of ions; or the ion source 20 can be configured to generate a series of pulses in which a pulsed beam of ions is emitted. Typically the number of pulses may be on the order of 10,000 during an analysis period, but this number can be increased or decreased depending on the application.

Accordingly, the ion source 20 can comprise of a continuous ion source, for example, such as an electron impact, chemical ionization, or field ionization ion sources (which may be used in conjunction with a gas chromatography source), or an electrospray or atmospheric pressure chemical ionization ion source (which may be used in conjunction with a liquid chromatography source), or a desorption electrospray ionization (DESI), or a laser desorption ionization source, as will be understood. A laser desorption ionization source, such as a matrix assisted laser desorption ionization (MALDI) can typically generate a series of pulses in which a pulsed beam of ions is emitted. The ion source 20 can also be provided with an ion transmission ion guide, such as a multipole ion guide, ring guide., or an ion mass filter, such as a quadrupole mass filter, or an ion trapping device, as generally know in the art (not shown). For brevity, the term ion source 20 has been used to describe the components which generate ions from the compound, and to make available the analyte ions of interest for detection. Other types of ion sources 20 may also be used, such as a system comprising of a tandem mass filter and ion trap.

A detector 22 (having one or more anodes 23) is also provided, which can be positioned downstream of the ion source 20, in the path of the emitted ions. Optics 24 or other focusing elements, such as an electrostatic lens can also be disposed in the path of the emitted ions, between the ion source 20 and the detector 22, for focusing the ions onto the detector 22.

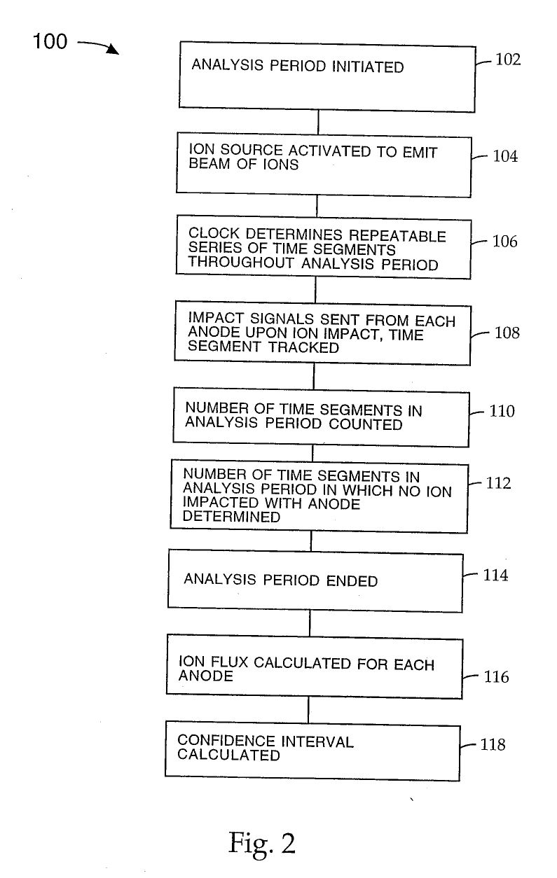

FIG. 2 sets out the steps of the method, referred to generally as 100, carried out by the spectrometer system 10 during an analysis period. Upon receipt of a command by the user to commence an analysis period (typically via the I/O device), the computation engine 14 is programmed to initiate an analysis period (Block 102). When an analysis period is commenced, a beam of ions from the ion source 20 are emitted (Block 104). As noted previously, these ions can be emitted in a series of pulses or as a continuous stream. Typically, before the analysis period is commenced, the engine 14 causes the clock 18 to determine a repeatable series of bins, the series of bins can be repeated during the analysis period (Block 106). It is not necessary that the bin period of each bin in the repeatable series be of equal length to every other bin. As will be understood, in a TOF mass spectrometer, for example, when the beam of ions is emitted in the form of a pulse (pulsed beam of ions as defined above), for every pulse, the clock 18 creates or tracks a corresponding pulse time segment for each bin in the repeatable series. As a result, the “time of flight” analysis can be made based on the data gathered for corresponding pulse time segments during an analysis period. Typically, bin periods are usually determined to correlate to the anode's 23 “dead” time ie. the time period between an anode 23 detecting an ion impact and resetting to be capable of detecting a subsequent ion impact, which by way of example only may be on the order of 14ns.

During every pulse, each time one or more ions impact with an anode 23, an impact signal is sent from the anode 23 which is received by the engine 14, and the engine 14 also tracks and stores in data storage 17—bin data corresponding to the pulse time segment in which the impact signal is sent, for that anode 23 (Block 108). The computation engine 14 is also programmed to count or determine the number of pulses in an analysis period (Block 110). Typically, the number of pulses will be predetermined for the application by the user and input into the CPU 12 prior to commencement of the analysis period. For at least one bin in the series, for each anode 23 the computation engine 14 is further programmed to determine the number of corresponding pulse time segments during the analysis period in which no impact signal was received from the anode 23 (Block 112).

For improved accuracy, it is generally preferable if in Block 112 the computation engine 14 is configured to calculate the number of corresponding pulse time segments in which no impact signal was received from the anode 23 and in which the anode 23 was alive and hence capable of detecting an ion impact. As previously noted, once an ion has impacted with an anode 23 on a detector 22, for a brief period of time thereafter (which may typically be approximately 14ns) that anode 23 (or channel) is “dead” and incapable of detecting the impact of ions. For improved accuracy, therefore, it is preferable if the computation engine 14 excludes corresponding pulse time segments in which an ion impact was detected within the “dead time” for the detector's 22 anodes 23.

Once the analysis period has ended (Block 114), the engine 14 is configured to calculate one or more ion fluxes for the beam of ions from the sample, separately for each anode 23 (Block 116). This is performed by analyzing the ion impact data corresponding to one bin (or range of bins) in the repeatable series. Typically, for each anode 23 the ion flux will be calculated for each discreet m/z bin or interval over the entire mass range covered by the bins in the repeatable series.

As will be understood, when reference is made to “calculating the ion flux” or variations thereof, this is intended to mean calculating an estimate of the real ion flux. The ion flux is correlated to the probability of not detecting an ion during a pulse time segment. Preferably, the ion flux is calculated according to the following equation:
ψ*=−1−n(p(x=0)) (EQ. 1)
where ψ* represents the estimated ion flux (as contrasted with ψ, representing the real ion flux); and where p(x=0) represents the probability of not detecting an ion (as determined by the computation engine 14 in Block 112) during the pulse time segments corresponding to a particular bin (or interval of bins) in the repeatable series.

The engine 14 may also be configured to calculate the confidence interval for the ion flux calculated in to EQ. 1 (Block 118). Confidence may first be calculated according to the following equation:
p(2\sqrt{ψ*}−2\sqrt{ψ}|<c)=2Φ(c\sqrt{n})−1 (EQ. 2)
where:

c is a small number determined by the user;

n is the number of pulses the detector 22 was not dead;

2Φ(c\sqrt{n})−1 represents confidence (in the range 0-1); and

Φ(c\sqrt{n}) is the integral of normal distribution PDF over the interval (−∞,c\sqrt{n}).

It is more convenient to define the difference between ψ* and ψthan \sqrt{ψ} and \sqrt{ψ}. If flux tolerance t is defined according to the equation:
t=|ψ−ψ*|/ψ, (EQ. 3)
then c, the confidence interval, may be calculated according to the following equation:
c=2(\sqrt{ψ*}−\sqrt{(1−t)ψ*}) (EQ. 4)
where c represents the confidence interval, ψ* represents the estimated ion flux calculated in EQ. 1; and where t represents tolerance or desired relative error for the estimated ion flux (as input by the user via the I/O device 16).

By way of background explanation, because of differences in initial ion velocity, beam focusing (and some other effects), ions of the same m/z (mass/charge) will not impact with the detector 22 at the same instance of time (i.e. within the same time bin or pulse time segment corresponding to the same bin in the repeatable series) in TOF instruments. It is assumed that the difference between the measured m/z of an ion and the actual m/z, (recorded m/z−true m/z) is a random variable and has a normal distribution with mean=0 and standard deviation a, where the value of cy depends on the characteristics of the system 10, but is irrelevant for the model, it is only important that a remains the same during the analysis, which is a valid assumption. It is also assumed that ions will resemble that distribution for any pulse, and that flux is constant over the pulse coordinate for each bin in the repeatable series.

Ion detection for each bin can be modeled as a Poisson process with parameter λ equal to ion flux at corresponding bin.

$$p ( x ) = \{ \begin{matrix}\frac{{ⅇ}^{- λ} {λ}^{x}}{x !} , & x = 0 , 1 , 2 , … , \\ 0 & otherwise\end{matrix} \qquad ( EQ . 5 )$$

Ion flux may be calculated according to the following equation:

$${ψ}^{*} = \frac{( number of counts )}{( number of pulses anode\_ 23 was alive )} \qquad ( EQ . 6 )$$

where ψ* is an estimation of real ion flux ψ. If the detector 22 could detect as many ions as emitted, then the reliability of ψ* would depend on the population size (ie. the number of pulses the detector 22 (or anode 23) was not dead) only.

In reality, measured ion flux is always equal or smaller than ψ because of the limitations of detectors 22 as explained above. For example, if two ions land on a detector 22 having four equally-sized anodes 23, the probability of detecting both ions is 0.75, assuming all four anodes 23 were alive. The probability of detecting and counting all ions impacting with the detector 22 (up to 4) decreases even more with a greater number of ions. This example shows how unreliable flux estimation by EQ. 6, above, is.

Alternatively, if 0 ions land on anode 23, 0 is counted, or:

$$p ( x = 0 ) = \frac{( number of “ zero \text{-} counts ” )}{( number of pulses anode\_ 23 was alive )} \qquad ( EQ . 7 )$$

Probability p(0) is a reliable statistic with respect to the number of emitted ions.

Assuming that ions impacting with the detector 22 and (not counting) is a Poisson process with parameter λ=ψ, where ψ is real ion flux, Equation 1 may be derived from EQs. 5 and 7.

By measuring probability of “zero-counts”, real ion flux can be estimated from EQ. 1 more reliably than from Equation 6.

While the system 10 has been illustrated and described as calculating ion flux according to EQ. 1, it should be understood that variations to this equation may be used, without departing from the spirit of this invention.

Although the method has been described in application to counting systems associated with time-of-flight mass spectrometers, it is also clear that the method can be applied to any mass spectrometer where ion counting is used, and where the ion arrival times are random.

For example, in triple quadrupole mass spectrometer systems, it is common to set the mass spectrometer to transmit ions of one mass-to-charge value (or to one combination of precursor/product mass value), and measure the ion intensity for a fixed period of time, for example for 100 milliseconds. During this time interval, the ions arrive at the detector at an average rate. The ion count rate is determined by counting the number of ions that arrive during the measurement time, and dividing by the time interval of measurement (eg 100 ms).

However, the detection system has an effective discrete time bin due to the response time of the detector (typically a channel electron multiplier), amplifier and discriminator. If two or more ions arrive at the detector during one response time, then only one ion is counted. The typical response time of the detection system is of the order of 15 nanoseconds. Hence the counting correction can be applied to such a counting system if the response time is known. By dividing the measurement time into effective time bins (each 15 ns long), the number of “0-count bins” can be measured, and EQ. 4 can be applied to provide a corrected value.

For example, if the measurement time is 100 ms, and a total of 1,000,000 ions are counted in this time, and if the response time of the detection system is known to be 15 ns, then the following correction can be applied:
Measured counts=1e6
Number of time bins in 100 ms=6.66e6
Measured ions per 15 ns time bin=1e6/6.66e6=0.16
Probability of 0-count time bins=0.84

Ion flux may be calculated according to the following equation:
ψ=−1n(p(x=0)) (EQ. 1A)

Therefore −1n(p(x=0))=0.174.

Thus the corrected ion counts per time bin is 0.174, so the corrected ion counts per 100 ms is 1.16e6.

In this case there is no separate correction for the dead time, because the dead time is the same as the time bin.

Thus, while what is shown and described herein constitute preferred embodiments of the subject invention, it should be understood that various changes can be made without departing from the subject invention, the scope of which is defined in the appended claims.

1. A method for calculating at least one ion flux for a sample during an analysis period, said method comprising the steps of:
(a) generating a plurality of pulses, wherein during each pulse a beam of ions is emitted from the sample;
(b) determining a repeatable series of bins, wherein each bin in the repeatable series will correspond to a corresponding pulse time segment in every pulse;
(c) detecting the impact of ions on a detector during each pulse;
(d) determining the total number of pulses during the analysis period;
(e) for at least one bin in the repeatable series, determining the number of corresponding pulse time segments in which no ion impact was detected; and
(f) calculating the ion flux, wherein said ion flux is correlated to the probability of not detecting an ion impact during pulse time segments which correspond to the at least one bin in the repeatable series.

2. The method as claimed in claim 1, wherein the ion flux is calculated substantially according to the following equation: ψ=−1n(p(x=0))
(a) wherein ψ represents the ion flux; and
(b) wherein p(x=0) represents the probability of not detecting an ion impact during pulse time segments which correspond to the at least one bin in the repeatable series.

3. The method as claimed in claim 2, wherein step (d) further comprises determining the number of pulse time segments corresponding to the at least one bin in the repeatable series in which no ion impact was detected.

4. The method as claimed in claim 3, wherein step (d) further comprises determining the number of corresponding pulse time segments corresponding to the at least one bin, in which no ion impact was capable of being detected.

5. A mass spectrometer comprising:
(a) an ion source for emitting a beam of ions from a sample through a plurality of pulses during an analysis period;
(b) a detector positioned downstream of said ion source;
(c) a clock configured to determine a repeatable series of bins, wherein each bin in the repeatable series will correspond to a corresponding pulse time segment in every pulse;
(d) a controller operatively coupled to the detector and to the clock and configured to determine the total number of pulses during the analysis period;
(e) wherein the controller is further configured to determine for at least one bin in the repeatable series, the number of corresponding pulse time segments in which no ion impact was detected during the analysis period; and
(f) wherein the controller is configured to calculate the ion flux corresponding to the at least one bin and wherein said ion flux is calculated to be correlated to the probability of not detecting an ion impact during pulse time segments which correspond to the at least one bin in the repeatable series.

6. The mass spectrometer as claimed in claim 5, wherein the controller is configured to calculate the ion flux correlated to the following equation:
ψ=1n(p(x=0))
(a) wherein ip represents the ion flux; and
(b) and wherein p(x=0) represents the probability of not detecting an ion impact during pulse time segments which correspond to the at least one bin in the repeatable series.

7. The mass spectrometer as claimed in claim 6, wherein the controller is further configured to determine the number of pulse time segments corresponding to the at least one bin in the repeatable series in which no ion impact was detected.

8. The mass spectrometer as claimed in claim 7, wherein the controller is further configured to determine the number of pulse time segments corresponding to the at least one bin, in which the detector was incapable of detecting an ion impact.

9. A method for calculating at least one ion flux for a sample, said method comprising the steps of:
(a) collecting a group of ions from the sample, wherein each ion in the group has substantially the same m/z as every other ion in the group;
(b) emitting the group of ions;
(c) detecting the impact of emitted ions on a detector during a pre-determined detection period;
(d) determining the total amount of time within the detection period in which the detector did not detect the impact of emitted ions; and
(e) calculating the ion flux of the ions, wherein said ion flux is correlated to the probability of not detecting an ion impact during the detection period.

10. A mass spectrometer comprising:
(a) an ion source for emitting a group of ions from the sample, wherein each ion in the group has substantially the same m/z as every other ion in the group;
(b) a detector positioned downstream of said ion source and configured to detect the impact of emitted ions on the detector during a pre-determined detection period;
(c) a clock configured to determine the total amount of time within the detection period in which the detector did not detect the impact of emitted ions; and
(d) a controller operatively coupled to the detector and to the clock and configured to calculate the ion flux of the ions, wherein said ion flux is correlated to the probability of not detecting an ion impact during the detection period.
